(19) United States
(12) Patent Application Publication
(10) Pub. No.: US 2005/0242296 A1
(43) Pub. Date: Nov. 3, 2005

(54) Optical detectors for infrared, sub-millimeter and high energy radiation

(76) Inventor: Marcos Y. Kleinerman, Amherst, MA (US)

Correspondence Address: MARCOS Y. KLEINERMAN, 215 SUNSET AVENUE, AMHERST, MA, 01002, US

(21) Appl. No.: 10/834,332

(22) Filed: Apr. 28, 2004

(51) Int. Cl. G01J 5/00

(52) U.S. Cl. 250/458.1

(57) ABSTRACT

Optical methods and devices for the thermal detection and imaging of infrared, sub-millimeter, millimeter and high energy radiation, wherein the thermal mass of the detector is minimized by the use of microscopic photoluminescent temperature probes having a weight mass which can be of the order of 10⁻¹¹ grams or smaller. Used for detection of high energy radiation, including quantum calorimetry, said temperature probes allow non-contact measurements free of electrical sources of noise like Johnson noise or Joule heating.

### FIELD OF THE INVENTION

The present invention relates to methods and devices for sensing and imaging infrared, sub-millimeter and high energy radiation by means of optical temperature sensors of microscopic dimensions and very small thermal mass attached to absorbers of said radiation.

### BACKGROUND OF THE INVENTION

Sensitive discrete and imaging detectors for X-ray and medium to long wavelength infrared or sub-millimeter radiation have been in great demand, especially for astronomy studies. The most sensitive devices are calorimetric, based on the measurement, with a bolometer, of a temperature rise caused by the absorption of said radiation, and require the minimization of the thermal mass of the detector in order to maximize the temperature rise. For terrestrial applications there is a need for thermal infrared detectors simpler and less expensive than the ones so far available.

Thermal detection of X-ray photons with energies of the order of 1 KeV or higher has progressed to the point that one can measure the temperature rise generated by the absorption of a single X-ray photon, and the measuring devices are known as “quantum calorimeters”.

Thermal detection of medium or long wavelength infrared or sub-millimeter radiation is based on the same principles, but the energy of an infrared photon is several orders of magnitude lower than that of an X-ray photon, so a thermal infrared detector is not, strictly speaking, a quantum detector, and typically requires the absorption of a relatively large number of infrared or sub-millimeter photons.

A thermal detector of radiation comprises two elements: (a) an absorber of the radiation, and (b) an associated temperature probe. The temperature rise measured by the probe is inversely proportional to the thermal mass of the detector. For a given mass, the thermal mass can be minimized by operating at liquid helium temperatures, where the heat capacity of the detector is approximately proportional to T³, where T is the absolute temperature in kelvins. The most sensitive detectors are, therefore, those that work at temperatures lower than 1K. On the other hand, many applications of infrared detection and/or imaging involve infrared intensities high enough that, although they still require absorbers of low thermal mass, they don't require cryogenic cooling of the detector.

Regarding thermal infrared detectors, an important recent advance was the substantial reduction of the thermal mass of the infrared absorber by the use of an essentially planar metalized micromesh geometry reminiscent of a spider-web, as described by Mauskopf et al. in the journal Applied Optics 36, pages 765-771 (1997). This reduces the mass of the absorber to a fraction of the mass of a continuous absorbing film (this fraction has been called “the fill factor”, and this term shall be used in this disclosure). But there was no comparable advance in the reduction of the thermal mass of the temperature probe. In fact, the micromesh absorber now leaves the temperature probe as the largest component of the detector thermal mass in the art prior to this invention. And if the probe is electrical, as are the temperature probes in existing radiation detectors, it is also the main source of noise in the detector system, due to Johnson noise and/or Joule heating.

### OBJECTIVES OF THE INVENTION

It is the main object of the present invention to reduce the thermal mass of discrete and imaging thermal detectors of infrared, sub-millimeter and high energy radiation, based on the use of new optical temperature probes of microscopic dimensions.

It is another object of the invention to provide simpler and less costly thermal infrared cameras for medical, industrial and security applications.

### DEFINITIONS

Within the context of this application, I am using the following definitions:
Light: optical radiation, whether or not visible to the human eye.
cm⁻¹: energy units expressed as the inverse of the corresponding wavelength λ given in centimeters (cm).
Excitation light: illuminating light which can generate luminescence in a luminescent material.
Luminescence: Light emitted by a material upon absorption of light or other radiation of sufficient quantum energy.
   The term includes both fluorescence and phosphorescence.
Luminescence quantum efficiency φ (also referred to as luminescence efficiency): the ratio of the number of luminescence photons emitted by a material to the number of photons of the excitation light it absorbed.
Short wavelength infrared radiation: radiation of wavelengths from about 0.7 to about 2.0 micrometers (μm).
Medium wavelength infrared radiation: radiation of wavelengths from about 2.0 to about 20 μm.
Long wavelength infrared radiation: radiation of wavelengths from about 20 to about 200 μm.
Sub-millimeter radiation: radiation of wavelengths from about 200 to about 1000 μm.
Micromesh absorber: an absorber of radiation from infrared to millimeter wavelengths comprised of a metalized web of fibers of a dielectric material.
Photoluminescence: Luminescence generated by the absorption of light.
Pixel: a minute area of illumination, one of many from which an image is composed, either in a sensitive surface on which an image to be processed is focused, or in the image shown in a display screen.
Thermal mass: the product m.Cᵥ, where m is the mass of the detector in grams and Cᵥ is its heat capacity per gram at the operating temperature.
λᵥ: wavelength of luminescence excitation light the absorption of which is substantially temperature-dependent.

### BRIEF SUMMARY OF THE INVENTION

An optical technique for sensing long wavelength infrared radiation based on thermally activated light absorption within a pre-selected wavelength region was disclosed in section 16, columns 49-50 of U.S. Pat. No. 5,499,313 to Kleinerman (see also references cited therein to earlier patents), and in section 3.2, columns 13-14 of U.S. Pat. No. 5,560,712, the teachings of which are incorporated herein by reference. The teachings of that patent allow the measurement of the temperature rise of a solid infrared absorbing film by an attached thin film of a photoluminescent material covering one side of the infrared-absorbing film. The invention disclosed herein uses the same temperature sensing principles, but it is a substantial improvement on the technology of said patent in that it provides an unprecedented reduction of the thermal mass of the infrared or sub-millimeter detector through the use of optical temperature probes of microscopic dimensions and a thermal mass much smaller than that of the micromesh absorbers recently introduced by Mauskopf et al. The system's advantages operate for both infrared, sub-millimeter and high energy radiation, as follows:
Needing no wires or other conductors, they are not subject to Johnson noise or Joule heating effects;
They require only weak light intensities for operation and, since most of the energy of the absorbed light is re-emitted as fluorescence, its heating effects and other potential contributions to noise is negligible;
Their thermal mass can be orders of magnitude smaller than that of electrical temperature probes;
Two-dimensional arrays of optical quantum calorimeters and infrared detectors should be simpler to construct than those using electrical thermometers, because all the elements of the array (‘pixels’) could be interrogated by a single light source, and their signals could be imaged into a single; inexpensive, low noise photo-electronic imaging device;
Used as imaging detectors in infrared astronomy, the infrared image, converted at the infrared sensor film into a visible or near infrared image, could be processed, stored and integrated by a simple TV-type visible imaging device;
They do not require low noise cryogenic electronic amplifiers, as the signals are optical and of wavelengths within the range of operation of sensitive photomultipliers and imaging devices.

They should, therefore, provide significantly improved sensitivity compared to currently used quantum calorimeters and infrared imaging bolometers, in addition to requiring much simpler instrumentation. The following are a detailed discussion of the physical processes common to both of the proposed devices and a discussion of how these devices could be constructed.

### BRIEF DESCRIPTION OF THE DRAWINGS

FIG. 1 is a simplified molecular energy diagram illustrating a temperature-dependent optical absorption process and luminescence conversion of the absorbed light in most photoluminescent materials.

FIG. 2 shows the temperature dependence of the normalized thermally activated fluorescence intensities of three organic dyes as a function of the inverse absolute temperature.

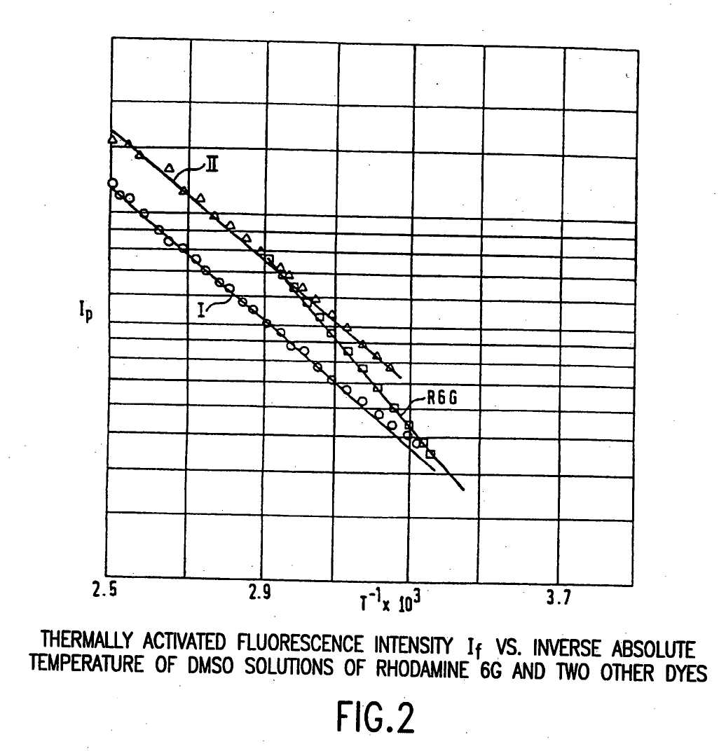

FIG. 3 shows the temperature dependence of the normalized thermally activated fluorescence intensity of a polymer solution of an organic dye as a function of the inverse absolute temperature.

FIG. 4 is a schematic diagram of a micromesh infrared sensor film according to the invention.

### 1. PHYSICAL BASIS OF RELATED PRIOR ART

Thermally-Activated Optical Absorption Processes in Photoluminescent Materials

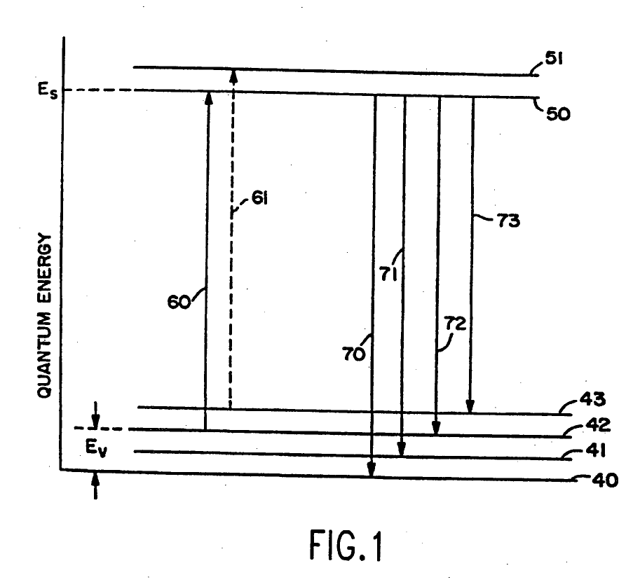

The technology to be described uses the fact that all solid and liquid materials which absorb light of visible or near infrared wavelengths have a temperature-dependent optical absorption at the long wavelength tail of an electronic absorption band. If the materials are photoluminescent and absorb only a small fraction of the intensity of the incident light, the intensity of the photoluminescence is the most convenient indicator of the magnitude of the optical absorption. This can be understood with the help of FIG. 1. The analysis that follows, taken from Kleinerman's U.S. Pat. No. 5,499,313, is deliberately oversimplified to emphasize the aspects most relevant to the invention. The quantitative relationships may not be followed rigorously in all practical systems. I do not wish to be bound by theory, and the account that follows must be taken as a model for understanding how the absorption of light of some wavelengths by a material, and the luminescence intensity generated by the absorbed light, can increase substantially and predictably with increasing temperature.

FIG. 1 shows a diagram of electronic energy levels and transitions which at least qualitatively describes, at the molecular level, most luminescent materials. The luminescent material includes, at the atomic or molecular level, luminescence centers having a ground electronic level comprising vibrational sublevels 40, 41, 42, 43 and other sublevels which, for the sake of simplicity, are not shown.

The lowest excited electronic energy level comprises sublevels 50, 51, and any other sublevels not shown. The vertical arrowed line 60 represents an optical electronic transition produced by the absorbed visible or near infrared excitation light from sub-level 42 to excited level 50, which have fixed energy levels Eᵥ and Eₛ, respectively, relative to the ground level 40 (The subscript “v” originated from the fact that in most photoluminescent materials the thermally excited sub-level is “vibronic”). The length of line 60 corresponds to the photon energy of the optical transition and, hence, to the specific wavelength λᵥ of the excitation light. This wavelength, usually in the long wavelength ‘tail’ of the electronic absorption band, obeys the relation
λᵥ=hc/(Eₛ−Eᵥ) centimeters (cm) (1)
where h is Planck's constant and c is the velocity of light in free space. The wavelength λᵥ can excite only molecules occupying vibrational level 2 and, to a smaller extent, molecules occupying slightly higher levels, the excitation of which is represented by the dotted vertical line 61. Luminescence emission of wavelengths λₗ occurs from level 50 to the different sub-levels of the ground electronic level, said emission represented by lines 70, 71, 72 and 73. As shown in FIG. 1, a considerable spectral portion of the emission occurs at photon energies higher (and wavelengths λₗₐ shorter) than that of the excitation light, and is commonly referred to as anti-Stokes emission.

In practice the photoluminescent material used in a temperature probe is usually a solid solution, glassy or crystalline, which constitutes the probe. The concentration of the photoluminescent material and the dimension of the probe along the direction of the interrogating light are chosen so that the probe absorbs only a temperature-dependent fraction α_{T} of the intensity of the nearly monochromatic excitation light within the temperature range of operation, and transmits the rest. At relatively low optical densities the fraction α_{T} of the intensity P of the interrogating light absorbed by the molecules occupying the sublevel 42 obeys the relation
α_{T}=KN₄₂/N₄₀ (2)
where
N₄₂ is the number of molecules of the photoluminescent material occupying vibrational level 42;
N₄₀ is the number of the molecules of the photoluminescent material occupying level 42; and
K is a constant specific to the probe
   Now
   N₄₂/N₄₀=exp(−Eᵥ/kT) (3)

At optical densities no greater than about 0.02 α is given approximately by
α_{T}32 K.exp(−Eᵥ/kT) (4)
where k is the Boltzmann factor and T the absolute temperature in kelvins. At optical densities greater than 0.02 the relationship between α and the Boltzmann factor exp(−Eᵥ/kT) becomes less linear, but equations (2) and (3) still hold, and the method can be used at high, low or intermediate optical densities.

The luminescence intensity I_{T} generated by the interrogating light absorbed by the probe obeys the relation
I_{T}=P₀.φK.exp(−Eᵥ/kT) photons.sec⁻¹ (5)
where P₀ is the intensity of the interrogating light, and φ is the luminescence quantum efficiency of the probe.

Probes made from materials having high φ values can produce large signal-to-noise ratios even with optical densities lower than 0.01, provided that the optical system has at least a moderately high collection efficiency for the probe luminescence. Such efficiency is easily obtainable with state-of-the-art systems.

The temperature coefficient of the luminescence intensity follows approximately the relation
(1/I_{T0})(dI_{T}/dT)=Eᵥ/kT² (6)
where I_{T0} is the luminescence intensity at a chosen reference temperature. For example, a material with an energy Eᵥ of 1200 cm⁻¹ has a coefficient of about two percent per kelvin at an ambient temperature of 295 K. Equation (6) assumes that the luminescence quantum efficiency φ is substantially independent of temperature over the temperature range of application of the method.

The model illustrated in FIG. 1 shows that this method for measuring temperature requires only a temperature-dependent change in the optical absorption coefficient of the luminescent probe material at wavelengths corresponding to photon energies lower than the energy Eₛ of the excited emissive level. This property is shared by virtually all luminescent materials. And equations (4) to (6) lead to the following conclusions:

A. The method does not require any temperature-dependent changes in the luminescence quantum efficiency, spectral distribution or decay time T of the probe luminescence.

B. For any given value of (Eᵥ/kT) the temperature coefficient of the luminescence intensity increases inversely proportionally to T.

C. Since α_{T} is directly proportional to [exp(−Eᵥ/kT)] it follows that, for similar values of α_{T}, the working values of Eᵥ must decrease for lower temperature ranges.

D. Operation at very low temperatures requires very stable monochromatic excitation wavelengths. At liquid helium temperatures, for example, the excitation energy should not vary by more than about 0.1 cm⁻¹.

Experimental tests of equations (4) to (6) have been carried out with liquid solutions of three different dyes dissolved in dimethyl sulfoxide (DMSO). Dye I and dye II are represented by the chemical structures 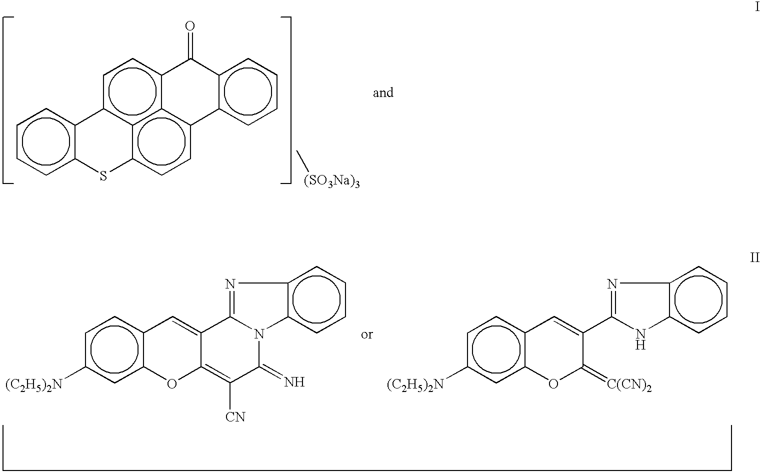
Dye I is the sulfonated derivative of Hostasol Red GG (American Hoechst Corp.). Dye II has been described in U.S. Pat. No. 4,005,111 by Mach et. al. The third dye is the well known Rhodamine 6G (R6G). Dye concentrations were about 10⁻⁴ Molar, with a path length of 1 cm. The dye solutions were illuminated by a 632.8 nanometers (nm) light beam from a helium-neon laser. The fluorescence intensity was monitored at a wavelength of 610 nm, shorter than the laser beam wavelength. The superiority of this method of temperature measurement compared to that based on light transmission measurements becomes evident from the fact that over the temperature interval from about 300 K (27° C.) to about 400 K (127° C.) the light transmission of the dye solution varies by less than two percent, while the intensity ratio of fluorescence light to transmitted light varies by about an order of magnitude.

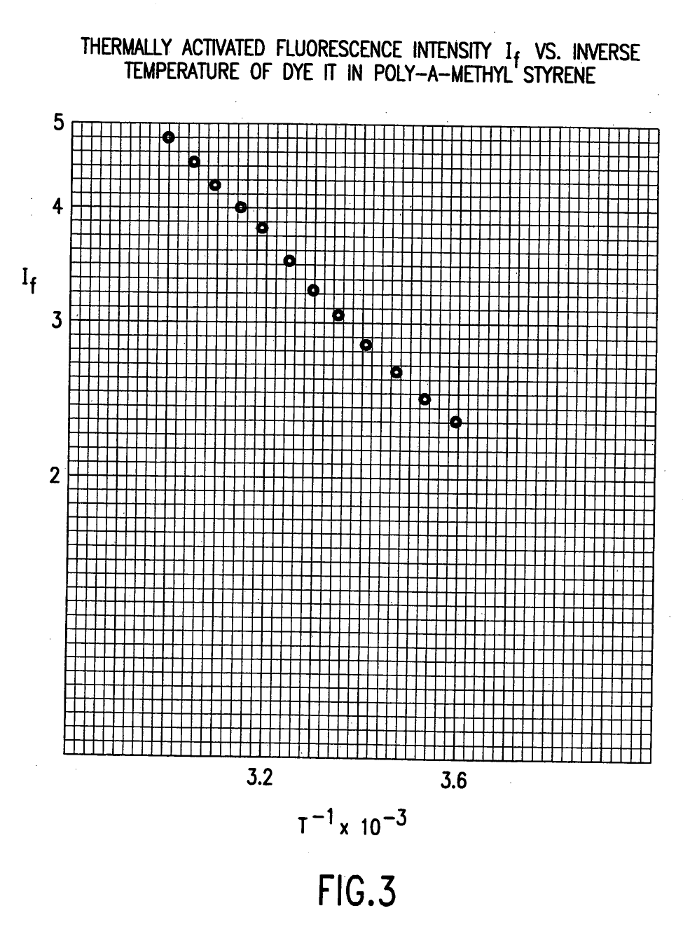

Dye II was incorporated into a poly-α-methyl styrene plastic at a concentration of the order of 0.01 Molar. FIG. 3 shows the temperature dependence of its normalized fluorescence intensity I_{f} over a temperature range of medical interest.

### 2. DETAILED DESCRIPTION OF THE INVENTION

### 2.1 Detectors for Infrared Radiation

In broad terms, there are two kinds of electrical long wavelength infrared detectors namely a) quantum detectors and b) bolometers.

In a quantum detector the absorption of infrared photons within an electronic absorption band generates charge carriers with a quantum efficiency q.

A bolometer is essentially a temperature-dependent resistor of relatively low thermal mass m.Cᵥ, where m is the mass of the detector in grams and Cᵥ is its heat capacity per gram at the operating temperature. The lower the thermal mass, the greater the temperature rise and, hence, the signal generated by the absorption of a unit of energy of the absorbed infrared radiation. Bolometers are sensitive over a much greater range of infrared wavelengths than quantum detectors. Cryogenically-cooled bolometers are especially sensitive. The most sensitive bolometers operate in the lower cryogenic regions, usually at liquid helium temperatures (4.2 K and below). The main advantage of operation at such low temperatures is that the heat capacity Cᵥ of the detector material (and that of virtually all solid materials) is orders of magnitude smaller than the Cᵥ at temperatures higher than about 20K.

For the sensing and processing of a thermal image, focal plane arrays have been widely used in recent years. These are electrically-interconnected line or two-dimensional arrays of individual small detectors. Their main disadvantage is that, for applications requiring high sensitivity, one has to keep the whole ensemble, including pre-amplification electronics, at cryogenic temperatures. The relative complexity of such an arrangement and the complexity of fabricating an array where all the elements (pixels) have the same response have kept the equipment costs relatively high.

Now, it is well known that the situation is very different for the processing of visible or near infrared images. The existing imaging devices (for instance CCD arrays) have high sensitivity and low noise even at ordinary temperatures, in addition to being relatively inexpensive and of small size. It follows, then, that if one had some x means for converting a thermal image into a visible or near infrared image with high efficiency and by an instrumentally simple method, this would represent an important technological and commercial advance.

This invention provides such a means. It is an improvement upon the temperature and infrared sensing technology disclosed in said U.S. Pat. No. 5,499,313 The only element of the sensing device that has to be cooled is a thin infrared-absorbing film having, in one preferred embodiment, an attached photoluminescent dot with an area of a few μm² and a thickness of the order of 1 μm. The technology does not require any temperature-dependent change in the luminescence quantum efficiency, decay time or spectral distribution of the photoluminescent material.

Discrete and Imaging Infrared Detector of Reduced Thermal Mass.

A detector which absorbs energy undergoes a temperature increase ΔT. Let us start from the temperature-sensing technology described in Section 1. above. Referring to FIG. 1 and equation (6), it can be noticed that for any value of (Eᵥ/kT) the temperature coefficient of the luminescence intensity I_{T} increases as the absolute temperature decreases. The relative increase Δl_{f} in the luminescence intensity follows the relation
ΔI_{f}/I_{f0}=(Eᵥ/kT)(ΔT/T)
or
ΔI_{f}/I_{f0}=(Eᵥ/kT)(H/mCᵥT) (7)
where H is the heat generated by the absorbed radiation, Cᵥ is the heat capacity per gram at the operating temperature and m is the mass of the detector in grams.

The thermal mass of the detector is the product mCᵥ as defined above and it has two components: a) the thermal mass of the radiation absorber, and b) the thermal mass of the temperature probe. From equation (7) above it follows that the signal Δl_{f} is inversely proportional to the mass of the detector. So, reducing the thermal mass of the detector is of the utmost importance. In recent years there was a breakthrough in the reduction of the thermal mass of the radiation absorber, by the use of the “spider-web” absorber mentioned above. This consists of a substantially planar micromesh of etched silicon nitride (Si₃N₄) fibers of width of the order of a micrometer (μm) and separated by a distance smaller than the wavelength of the radiation to be detected, and preferably greater than the width of the fibers. A metal coating less than 0.1 μm thick is usually applied to the micromesh to enhance absorption of infrared radiation. Under these conditions a substantial fraction of the intensity of the incident infrared radiation is absorbed, but radiation of shorter wavelength, mainly visible light, can pass through the micromesh.

The spider-web absorber was developed mainly for very long wavelength infrared (>100 μm) and sub-millimeter and millimeter radiation, the detectors for which must have necessarily a larger diameter—and, hence, thermal mass—than those needed for the more commonly detected middle infrared (of the order of 10 μm). As the weight mass of the absorber is at least an order of magnitude smaller than that of a solid absorber, so is the thermal mass. For the middle infrared region the inter-fiber distance must be shorter, but the thermal mass of the absorber can still be made much smaller than that of a solid film absorber.

But the spider-web technique does not appreciably affect the thermal mass of the temperature probe. This is usually a semiconductor thermistor, but can also be a transition edge superconductor operated at the superconductive transition temperature. In either case, in detectors for infrared radiation of wavelengths shorter than 50 μm the thermal mass of the temperature probe is about an order of magnitude (or more) greater than that of the spider-web absorber.

The improvement provided by this invention takes advantage of the fact that the photoluminescent temperature probe can be interrogated with light of wavelength shorter than 1 μm, and such light can be focused on a probe of similar dimension. Therefore, the temperature probe can be a microscopic dot, with an area much smaller than that of the infrared absorber. And since the thickness of the dot need not be much greater than 1 or a few μm, its weight mass can be much smaller than one tenth of the mass of an optimized infrared absorber. In other words, the thermal mass of the detector at its operating temperature can be much smaller than 1.1 times the mass of the absorber alone.

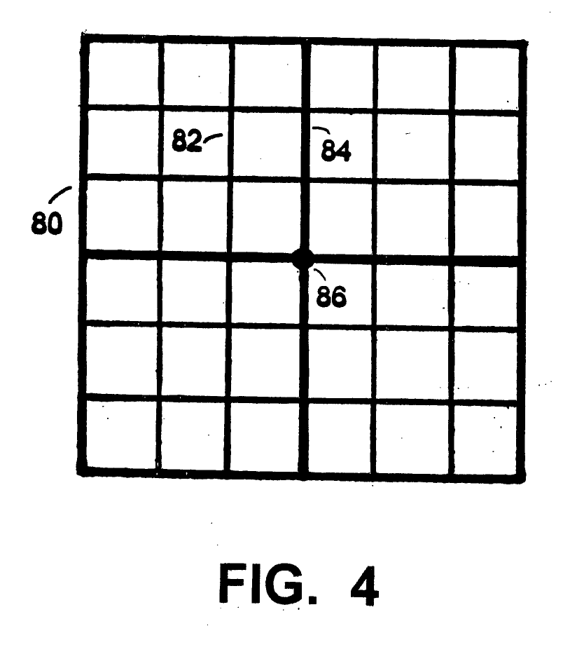

A schematic diagram of the absorber/probe system is shown in FIG. 4. The micromesh film 80 is comprised of the set of relatively thin fibers 82, with a thickness and width not much greater than 1 μm, and the fibers 84, which are just wider enough to provide a support for the dot YZ of the photoluminescent temperature probe and for providing a more rapid heat conduction path to said probe than allowed by the thinner fibers 82. The fibers are disposed over a metallic film, for example gold, usually less than 100 nm thick.

In order to process an infrared image the area of the absorbing film is made sufficiently large to comprise the desired number of ‘pixels’, each pixel including its own photoluminescent temperature-sensing dot.

The main characteristics of this invention are as follows:

a) The thin photoluminescent dot is excited by light of wavelength λᵥ to emit visible or near infrared luminescence light of wavelengths λ_{f} within the spectral range of operation of sensitive TV cameras.

b) The infrared radiation to be detected and/or measured is focused on the infrared-absorbing film, thus causing a temperature rise of the film corresponding to the intensity of the infrared radiation incident on the film;

c) The absorption of excitation light of wavelength λᵥ increases in a known manner with increasing temperature, causing the film to emit more intense luminescence light from the points which were heated by the infrared radiation incident on the film. The stronger the infrared radiation falling on any image point on the film, the stronger the luminescence light emitted from that point, so that the film generates a visible image corresponding to the infrared image incident on the film.

d) Light of any infrared wavelengths, from the near infrared to the far infrared (up to millimeter waves) cause heating when absorbed. Therefore, the invention can detect and process infrared images over a very wide infrared wavelength range.

e) A decrease in temperature decreases the background noise and increases the temperature coefficient of the signal. Thus, the technique is expected to be more sensitive at liquid nitrogen temperatures, and orders of magnitude more sensitive at liquid helium temperatures.

A Preferred Embodiment of a Discrete Infrared Detector

The discrete detector of this example is intended to measure infrared spectra within the wavelength range from about 2.5 μm to 25 μm in a Fourier Transform Infrared Spectrometer, and is designed for operation at temperatures lower than ambient, whether Peltier-cooled or, for higher sensitivity, at about 77K. Because said wavelength range includes relatively short wavelengths, a micromesh absorber offers a smaller improvement than can be obtained at longer infrared wavelengths, so one may use a continuous thin infrared absorbing film with a diameter of about 30 μm and a thickness not much greater—and preferably smaller—than about 1 μm. The main reduction of the thermal mass of the detector is then realized by using, as the temperature probe, a microscopic photoluminescent temperature probe attached to the center of the absorbing film and having an area of the order of 1 μm². This can be a dot of a highly absorbing semiconductor like cadmium telluride (CdTe), which is strongly fluorescent at 77K. Alternatively, the temperature probe can be in the form of a thin fiber attached to the plane of the absorber. In operation, the photoluminescent temperature probe is excited with CW light of wavelength λᵥ, which generates a CW photoluminescence background. The infrared radiation to be detected is AC-modulated before it is focused on the infrared absobing film, thus increasing the film temperature and generating on the temperature probe an AC-modulated photoluminescence with an intensity determined by the temperature rise of the film. The intensity of the AC-modulated photoluminescence can be measured by a suitable light detector like a photodiode or a photomultiplier.

A Preferred Embodiment of a Sensor of Long Wavelength Infrared and Sub-Millimeter Radiation.

The detection of long wavelength infrared and sub-millimeter radiation has recently become a fast-growing area of astronomy. It was, in fact, work in this area that led to the invention of the spider-web micromesh absorber, as reported in the above cited article by Mauskopf et a/. Not coincidentally, it is in the detection of radiation of said long wavelengths that a micromesh absorber is most advantageous. As the radiation wavelength increases one can increase the separation between the fibers of the micromesh, and hence decrease the fill factor to not more than a few percent of the value of a continuous film of the absorber. Under these conditions, the thermal mass of the detector is determined by the mass of the bolometer. And this is precisely this limitation that the present invention is design to overcome, as the thermal mass of the temperature probes of this invention can be orders of magnitude smaller than that of bolometers of the present art.

A Preferred Embodiment of a Micromesh Sensor Film for Long Wavelength Infrared and Sub-Millimeter radiation is illustrated in FIG. 4. The micromesh film 80 is comprised of the set of relatively thin fibers 82, with a thickness and width not much greater than 1 μm, and the fibers 84, which are just wider enough to provide a support for the dot 86 of the photoluminescent temperature probe and for providing a more rapid heat conduction path to said probe than allowed by the thinner fibers 82.

Alternate Embodiment Using an Infrared Absorbing Material Doped with a Photoluminescent Material.

The dielectric material of the micromesh infrared absorber may itself be doped with a visible or near infrared photoluminescent material. In fact, silicon nitride films of thickness of 1.2 μm have been doped with about 4.0×10¹² Si atoms.cm⁻² [Y. Q. Wang et al, Appl. Phys. Lett. 83, 3474 (2003)]. In such case the micromesh absorber is its own temperature probe, and can be interrogated with the technology described in section 1. above, with light of a suitable wavelength λᵥ injected along the length of one or more of its fibers.

Imaging Infrared Detectors. Examples of Preferred Embodiments.

A micromesh infrared absorbing film having an area suitable to comprise the required number N of pixels, is used in a portable thermal infrared imager for industrial, security and medical applications. The main spectral range of interest is from about 8 to 14 μm. In this case a planar Si₃N₄ spider web absorber is suitable, with a fiber-to-fiber distance of about 6 μm and a fiber thickness not much greater than about 1 μm. The fill factor of the spider web absorber can then be about 0.30 or smaller. The detector is designed for operation at temperatures within the range generated by thermoelectric (Peltier) coolers, that is from about −50° C. to about −100° C. The micromesh film is nearly square (but could be nearly circular) with a side length of about 0.50 cm. A two-dimensional array of temperature sensing photoluminescent dots at a distance of about 25 μm from each other determines the number of approximately square ‘pixels’ and their dimensions. The photoluminescent material of the temperature sensing dots are the so-called “quantum dots”, namely semiconductor nanocrystals, based on CdTe or CdSe cores. These nanocrystals have a much higher fluorescence efficiency at temperatures in which the fluorescence of ‘bulk’ CdTe or CdSe is quenched, thus allowing uncooled or Peltier-cooled operation.

In operation, the infrared image is focused on the micromesh infrared absorbing film while the photoluminescent dots are excited with DC light of wavelength λᵥ. The infrared image causes a two-dimensional temperature distribution and, hence, a luminescence image on the film corresponding to the focused infrared image. The luminescence image is focused on a photo-electronic imaging device and processed into a visual diplay of the infrared image.

Instead of a two-dimensional array of temperature sensing photoluminescent dots one could use a micromesh absorber itself as a temperature probe, provided the fibers of the micromesh are made of an optically homogeneous material doped with a photoluminescent material.

In another preferred embodiment, the imaging infrared detector is a two-dimensional array of closely spaced square or circular individual detectors, each individual detector having its own photoluminescent temperature probe, the spacing between said individual detectors being substantially smaller than the diameter or the side length of the individual detectors.

Simultaneous Infrared and Visible Imaging

A ‘spider-web” micromesh infrared absorber whose fibers have a spacing greater than their diameter and greater than about 1 μm is or can be made partly transparent to visible light, and that transparency is not appreciably affected by a luminescent temperature probe (dot) of diameter not greater than a few μm². Thus, such absorber/probe combination lends itself to simultaneous infrared and visible imaging, as the most suitable photo-electronic imaging devices (for example CCD arrays) for processing the luminescent image into a visible display are also the most suitable visible light imaging devices. In practice the wavelengths of the luminescence emitted by the temperature probe are mostly longer than about 650 nm, and the wavelengths of the visible image are mostly shorter. The infrared image and the visible light image of the same scene are both focused on the micromesh absorber comprised of a number N of pixels, each pixel having at least one temperature sensing dot. The infrared image is converted by the luminescent temperature sensing dots into a luminescence intensity distribution which, after subtracting the background luminescence from each pixel (that is, the luminescence intensity in the absence of the infrared radiation), corresponds to the intensity distribution of the infrared image. The visible image from the same scene is at least partially transmitted through the micromesh. Since the visible image and the luminescence image have different wavelengths, they can be separated by optical filters and processed separately by one or more photo-electronic image devices.

Discrete and Imaging Detectors for Sub-Millimeter and Millimeter Radiation

The advantages of the microscopic photoluminescent temperature probes of this invention are most evident in the sensing of far infrared, sub-millimeter or millimeter radiation. The mass of the Si₃N₄ micromesh absorber is a much smaller fraction of the mass of a continuous absorber film, so the fill factor and, hence, the fraction of the mass of the absorber compared to that of a continuous solid film, can be less than 0.10, as the fiber-to-fiber distance can be greater than 20 μm. The mass of the photoluminescent temperature probe can be less than 10⁻³ of the mass of a continuous probe covering the area of a continuous absorber film. The linear dimensions of a discrete detector depend on the desired wavelength range of the radiation to be detected. A two-dimensional array of said detectors could be used an imaging detector.

Many sub-millimeterand millimeter radiation detectors are used in astronomy studies. Since the signals are usually very weak, the needed sensitivity requires the cooling of the detectors to sub-kelvin temperatures, at which the heat capacity of the detector is orders of magnitude smaller than at ordinary temperatures.

The dimensions of the radiation absorber have to be greater than the radiation wavelength. Therefore, and depending on said wavelength, the area of the absorber can be several mm².

When operated at sub-kelvin temperatures, the temperature probe must be a photoluminescent material the molecules of which have the same orientation in space and be identical, at least to the extent of having identical or nearly identical electronic and thermally excited energy levels, with energy differences no greater than a few cm⁻¹.

Application to Imaging Detectors for Infrared Astronomy.

Infrared astronomy studies require the measurement of extremely small intensities of infrared and sub-millimeter radiation. From equation (7) above we know that the temperature signal ΔI_{f} is proportional to (mCᵥT)⁻¹. It is well known that the value of Cᵥ at temperatures below 4K is several or many orders of magnitute lower than at liquid nitrogen temperatures (77K or below). Therefore, current instruments for said studies use semiconductor or transition-edge superconductive detectors cooled below 4K. Even at these temperatures it is necessary to reduce m as far as practical.

Now consider a two-dimensional array of square infrared absorbing pixels. Each pixel is made of a weblike mesh of silicon nitride, which absorbs infrared radiation and conducts the energy to a tiny dot of the photoluminescent material that sits at the center of the web. The area of each pixel is d², where d is comparable to the wavelength of the infrared radiation incident on the array. Now, the linear dimensions of the fluorescent probes attached to each of those pixels could be more than an order of magnitude smaller than d, because they need not be much greater than the wavelength of the fluorescence excitation light, typically shorter than 800 nanometers. If the fluorescent probe is chosen from the already mentioned phthalocyanines or naphthalocyanines and their chelates with zinc (Zn), magnesium (Mg) or aluminium (Al), their absorption coefficients are so high that the optical thickness of the probe need not be much greater than 1 micrometer. Therefore the fluorescent film should make only a relatively small contribution to the thermal mass of the detector, much smaller than that of the electrical bolometers currently being used.

Now, a long wavelength infrared image focused on said two-dimensional array of infrared absorbing pixels, each having a small, thin dot of the fluorescent probe attached to it and illuminated by the fluorescence excitation light, will be converted into an image of wavelength within the spectral range of operation of presently used low light level TV cameras, and the system cost should be much less than the cost of the imaging devices presently used in infrared astronomy.

Examples of Preferred Materials for Optical Thermometers for the Cryogenic Region.

Virtually all fluorescent materials should behave according to equations 4-6 above, but the requirement of a low thermal mass narrows the choice of fluorescent materials to those that have very high absorption coefficients to the fluorescence excitation light. Fortunately the class of thin film solar cells provides suitable candidates. CdTe and CdZnTe have both high absorption coefficients and high fluorescence quantum efficiencies. CdTe, for instance, has an absorption coefficient a of the order of 10⁵ cm⁻¹. Other promising candidates are fluorescent dyes with very high molar absorption coefficients, for example phthalocyanines or naphthalocyanines and their chelates with zinc (Zn), magnesium (Mg) or aluminium (Al).

Application to Quantum Calorimeters for X-rays and Other High Energy Particles

Quantum calorimeters are essentially devices for measuring the thermal energy deposited by pulses of radiation on an absorber/detector capable of generating a temperature-dependent signal. They are used extensively in astrophysics for measuring the energy deposited by X-rays and other high energy particles. It is usually required to measure the energy deposited by single particles in the KeV range, with a resolution of several eV. Because the energies being measured are usually very low, the temperature increase would be minimal and unmeasurable unless the particle absorber in the calorimeter is cooled to sub-kelvin temperatures. In this case the heat capacity Cᵥ of the absorber is so small that even a single X-ray photon or particle of similar energy can generate a temperature rise in it of a few milliKelvins.

A quantum calorimeter consists of a material that absorbs efficiently the energy of the incident particle, and a temperature probe attached thereto. In state-of-the-art calorimeters the temperature sensor is either a suitably doped semiconductor thermistor or a superconducting transition edge sensor (TES). A TES is much more sensitive than a thermistor for a given heat capacity of the absorber/sensor system but, because it is sensitive only in the limited temperature range of the superconducting transition, its heat capacity has to be sufficiently large to keep the temperature within the range of the transition. Both the thermistor calorimeters and the TES calorimeters are subject to Johnson noise and Joule heating limitations, and their energy resolutions are similar. The following was copied from http://constellation.qsfc.nasa.gov/docs/technology/calorimeters.html

Superconducting transition-edge sensors (TES) can achieve values of a more than an order of magnitude higher than semiconductor thermistors. Because they are only sensitive in the limited temperature range of the superconducting transition, however, the heat capacity must be large enough to keep the temperature within the transition upon the absorption of the highest energy X-ray of interest in a particular experiment. Thus, for the astronomical X-ray band, the theoretical resolution for TES-based and semiconductor-based microcalorimeters is about the same. The advantage of TES-based devices is that the larger heat capacity budget permits a wider choice of absorber materials. Normal metals, off-limits to semiconductor-based calorimeters, can be used with TES-based calorimeters, exploiting the rapid and efficient thermalization that occurs in metals. This permits the design of a fast device. Electrothermal feedback, present in any resistive calorimeter because the bias power into the device changes as its resistance changes, can be particularly dramatic in a high—a device. Voltage-biasing of a TES produces extreme negative feedback, permitting stable biasing within the narrow superconducting transition and actually making the recovery time of the thermal pulses faster than the intrinsic thermal time constant. Energy resolution of 4.7 eV at 6 keV has already been demonstrated with a single pixel TES device and 2.38 eV at 1.5 keV with count rates in excess of 400 counts s⁻¹ on another device. Low-noise read-out of low-resistance transition-edge thermometers is achieved through series arrays of superconducting quantum interference devices (SQUIDs).

The Space Research Organization of Netherlands (SRON) uses copper foils of dimensions 250μ×250μ×0.8μ, attached to a TES temperature probe.

The ASTRO-E XRS X-ray calorimeter jointly developed by NASA/Goddard and the University of Wisconsin uses high atomic number absorbers like HgTe several microns thick and having an area of about 0.25 mm², a volume of the order of 5×10⁻⁴ mm³. This is in thermal contact with a thermistor that inevitably increases appreciably the thermal mass of the system, in addition to generating Johnson noise and Joule heating.

Now, the principles discussed above permit one to attach to be absorber (for example the HgTe absorber in the ASTRO-E XRS calorimeter), instead of an electrical thermometer, a microscopic optical temperature probe made, for example, of CdTe with dimensions, say, 0.010 mm×0.002 mm×0.002 mm, a volume of 4×10⁻⁸ mm³, four orders of magnitude smaller and, hence, negligible contribution to the calorimeter thermal mass. An alternate temperature probe is a microscopic thin film of a metal chelate of phthalocyanine or a naphthalocyanine.

In a preferred embodiment the calorimeter is kept at a suitably cold temperature Tₒ, for example 0.06 kelvins. The X-ray absorber itself, for example HgTe, does not have a high fluorescence quantum efficiency. When an X-ray quantum enters the absorber and is thermalized therein, the temperature increase produces a pulsed increase in the fluorescence intensity of the fluorescent temperature probe attached to the absorber as a function of the energy of the absorbed X-ray quantum.

Since changes may be made in the foregoing disclosure without departing from the scope of the invention herein involved, it is intended that all matter contained in the above description and depicted in the accompanying drawings be construed in an illustrative and not in a limiting case.

1. An essentially planar detector of electromagnetic or other radiation, said detector including an essentially planar absorber of said radiation having dimensions, area and thermal mass not substantially greater than minimally needed for the capture of a desired fraction of the intensity of said radiation incident on the detector and at least one temperature probe attached to or incorporated into said absorber and comprised of a photoluminescent material so characterized that, when illuminated with light of suitable visible or near infrared wavelengths λᵥ and an intensity P₀, it absorbs a fraction αP₀ of the intensity of said illuminating light, thereby generating a luminescence light separable from the illuminating light, at least part of the intensity of which is emitted from the probe at visible or near infrared wavelengths λ_{f} different from λᵥ, where α is a temperature-dependent fraction smaller than unity, the value of which varying in a known manner with varying temperature within the temperature range of operation of the probe, the intensity of said luminescence light being substantially proportional to the value of α, the detector being characterized by undergoing a temperature rise upon the absorption of said radiation and further so characterized that its thermal mass at its operating temperature is not significantly greater than 1.1 times the mass of said absorber alone:

2. A detector as claimed in claim 1 and adapted to convert an image of radiation of medium infrared or longer wavelengths emitted and/or reflected from one or more objects and focused on the detector into a corresponding image of visible or near infrared wavelengths, said detector including an essentially planar absorber of said radiation having dimensions, and an area A suitable for the capture of said image, said area including a number N of pixels, each pixel having an area of about A/N and having attached to or incorporated in it at least one temperature probe.

3. A two-dimensional array of detectors, each of said detectors as claimed in claim 1, and adapted to convert an image of radiation of medium infrared or longer wavelengths emitted and/or reflected from one or more objects and focused on the array into a corresponding image of visible or near infrared wavelengths, said array having dimensions and an area suitable for the capture of said image.

4. An arrangement for sensing electromagnetic or other radiation, comprising
a) a detector as claimed in claim 1;
b) light source means for illuminating said temperature probe with said light of wavelengths λᵥ and pre-determined intensity, thereby generating said luminescence light of wavelengths including λ_{f} and an intensity indicative of the probe temperature;
c) optical means for directing a fraction of the intensity of the luminescence light of wavelengths including λ_{f} to photodetector means; and
d) photodetector means for sensing changes of the intensity of said luminescence light of wavelengths λ_{f}, emitted by said probe, said change being an indicator of the increase of the probe temperature and, hence, of the energy of said radiation absorbed by said absorber.

5. An arrangement as claimed in claim 4 and adapted to detect infrared and longer wavelength radiation, wherein the absorber has a thickness not greater than about 10 micrometers and is comprised of a metalized micromesh of fibers of a pre-selected material such that the mass of the absorber is much smaller than the mass of a continuous solid film of the same material and thickness, and wherein the mass of said temperature probe is substantially smaller than the mass of said micromesh absorber.

6. An arrangement as claimed in claim 5 wherein said fibers are separated from each other by a distance not shorter than the width of said fibers and not longer than the wavelength of the infrared or longer wavelength radiation to be sensed.

7. An arrangement for converting an image of radiation of medium infrared or longer wavelengths emitted and/or reflected from one or more objects into a corresponding image of visible or near infrared wavelengths, comprising
a) A detector for said radiation as claimed in claim 2 and adapted to convert an image of said infrared or longer wavelengths into a corresponding image of visible or near infrared wavelengths, wherein the absorber has a thickness not greater than about 10 micrometers and is comprised of a metalized micromesh of fibers of a pre-selected material such that the mass of the absorber is much smaller than the mass of a continuous solid film of the same material and thickness;
b) optical means for focusing said image of said radiation on said detector;
c) light source means for illuminating the temperature probes attached to or incorporated into said pixels with light of visible or near infrared wavelengths λᵥ and pre-determined intensity, thereby generating at each probe a luminescence light of visible or near infrared wavelengths including λ_{f} different form λ_{f} and an intensity indicative of the temperatures of said probe, said temperatures being indicative of the intensity of said radiation incident on said pixel, thus forming a visible or near infrared luminescence light image corresponding to the image of said medium infrared or longer wavelengths;
d) optical means for directing and focusing said luminescence light image into the light-sensing surface of a photo-electronic image device; and
e) a photo-electronic image device for processing said luminescence light image into a visible display corresponding to the image of said radiation.

8. An arrangement for converting an image of radiation of medium infrared or longer wavelengths emitted and/or reflected from one or more objects into a corresponding image of visible or near infrared wavelengths, comprising
a) A two-dimensional array of detectors as claimed in claim 3, wherein the radiation absorbers in each of said detectors are comprised of a metalized micromesh of fibers of a pre-selected material such that the mass of the absorber is much smaller than the mass of a continuous solid film of the same material and thickness;
b) optical means for focusing said image of said radiation on said detector;
c) light source means for illuminating the temperature probes attached to or incorporated into said detectors with light of visible or near infrared wavelengths λᵥ and pre-determined intensity, thereby generating at each probe a luminescence light of wavelengths including λ_{f} different from λᵥ and an intensity indicative of the temperatures of said probe, said temperatures being indicative of the intensity of said radiation incident on said pixel, thus forming a visible or near infrared luminescence light image corresponding to the image of said medium infrared or longer wavelengths;
d) optical means for directing and focusing said luminescence light image into the light-sensing surface of a photo-electronic image device; and
e) a photo-electronic image device for processing said luminescence light image into a visible display corresponding to the image of said radiation.

9. An arrangement as claimed in claim 4 and adapted to measure the energy of a single quantum of X-ray or other high energy radiation, wherein said planar absorber is made of a compound comprised of heavy elements having a relatively high absorption cross-section for said X-ray or other high energy radiation.

10. An arrangement as claimed in claim 5 wherein said absorber is doped with said photoluminescent material and is also the temperature probe.

11. An arrangement as claimed in claim 7 and additionally adapted to receive and display the visible image of the same object or objects, wherein said detector is transparent to at least a substantial fraction of the intensity of visible light incident on the absorber, the arrangement additionally comprising optical means for separating the visible radiation emitted and/or reflected from said object or objects and transmitted through said micromesh of fibers and for focusing said visible radiation on a photo-electronic image device.

12. An arrangement as claimed in claim 8 and additionally adapted to receive and display the visible image of said object or objects, wherein said array of detectors is transparent to at least a substantial fraction of the intensity of visible light incident on the absorber, the arrangement additionally comprising optical means for separating the visible radiation emitted and/or reflected from said object or objects and transmitted through said micromesh of fibers and for focusing said visible radiation on a photo-electronic image device.

13. A method for sensing electromagnetic or other radiation, comprising the steps of
a) providing a detector for said radiation as claimed in claim 1;
b) Illuminating said temperature probe with light of visible or near infrared wavelengths λᵥ and pre-determined intensity, thereby generating luminescence light of wavelengths including λ_{f} different from λᵥ and an intensity indicative of the probe temperature, said temperature being determined by the intensity of said radiation absorbed by said absorber; and
c) measuring the change of the intensity of said luminescence light of wavelengths including λ_{f} caused by the absorption of said radiation.

14. A method as claimed in claim 13 and adapted to sense infrared and longer wavelength radiation, wherein said planar absorber is comprised of a micromesh of fibers such that the mass of the absorber is much smaller than the mass of a continuous solid film of the same material and thickness, and wherein the mass of said temperature probe is substantially smaller than the mass of said micromesh absorber.

15. A method as claimed in claim 13 wherein said fibers are separated from each other by a distance not shorter than the width of said fibers and not longer than the wavelength of the infrared or longer wavelength radiation to be sensed.

16. A method as claimed in claim 14 and adapted to measure the energy of a single quantum of X-ray or other high energy radiation, wherein said planar absorber is made of a compound comprised of heavy elements having a relatively high absorption cross-section for said X-ray or other high energy radiation.

17. A method for processing an image of radiation of medium infrared or longer wavelengths emitted and/or reflected from one or more objects into a visible image, comprising the steps of
a) providing a detector as claimed in claim 2;
b) focusing said image of radiation of medium infrared or longer wavelengths into said detector;
b) illuminating the temperature probes of all pixels in said detector with light of visible or near infrared wavelengths λᵥ and pre-determined intensity, thereby generating at each probe a luminescence light of visible or near infrared wavelengths including λ_{f} different from λᵥ and an intensity indicative of the temperatures of said probe, said temperatures being indicative of the intensity of said radiation incident on said pixel, thus forming a luminescence light image corresponding to the image of said radiation; and
d) directing and focusing said luminescence light image into the light-sensing surface of a photo-electronic image device.

18. A method for processing an image of radiation of medium infrared or longer wavelengths emitted and/or reflected from one or more objects into a visible image, comprising the steps of
a) providing a two-dimensional array of detectors as claimed in claim 3;
b) focusing said image of radiation of medium infrared or longer wavelengths into said array;
b) illuminating the temperature probes in said array with light of wavelengths λᵥ and pre-determined intensity, thereby generating at the probe of each detector a luminescence light of wavelengths including λ_{f} different from λᵥ and an intensity indicative of the temperatures of said probe, said temperatures being indicative of the intensity of said radiation incident on the detector to which said probe is attached or into which it is incorporated, thus forming a luminescence light image corresponding to the image of said radiation; and
d) directing and focusing said luminescence light image into the light-sensing surface of a photo-electronic image device.
